(19) United States
(12) Patent Application Publication
(10) Pub. No.: US 2024/0266518 A1
(43) Pub. Date: Aug. 8, 2024

(54) ELECTROCHEMICAL DEVICE

(71) Applicant: Ningde Amperex Technology Limited, Ningde (CN)

(72) Inventor: Xin LI, Ningde (CN)

(73) Assignee: Ningde Amperex Technology Limited, Ningde (CN)

(21) Appl. No.: 18/622,217

(22) Filed: Mar. 29, 2024

Related U.S. Application Data
(63) Continuation of application No. PCT/CN2022/073239, filed on Jan. 21, 2022.

(51) Int. Cl. H01M 4/36; H01M 4/02; H01M 4/505; H01M 4/62; H01M 10/0525

(52) U.S. Cl. CPC H01M 4/366; H01M 4/505; H01M 4/625; H01M 10/0525; H01M 2004/021; H01M 2004/027

(57) ABSTRACT

An electrochemical device includes a negative electrode. The negative electrode includes a negative active material layer. The negative active material layer includes a negative active material. The negative active material includes a magnesium-doped carbon-silicon-oxide material. A surface of a crystalline oxide of the magnesium-doped carbon-silicon-oxide material is coated with a carbon nanotube cladding layer. By employing the magnesium-doped carbon-silicon-oxide material coated with a carbon nanotube capping layer, the electrochemical device can improve the first-cycle Coulombic efficiency of the electrochemical device, optimize structural stability of the electrochemical device during cycling, and in turn, improve a cycle capacity retention rate and cycle performance of the electrochemical device.

### CROSS REFERENCES TO RELATED APPLICATIONS

This application is a continuation application of PCT/CN2022/073239, filed on Jan. 21, 2022, the disclosure of which is hereby incorporated by reference in its entirety.

### TECHNICAL FIELD

This application relates to the field of energy storage, and in particular, to a negative active material and an electrochemical device containing same, especially a lithium-ion battery.

### BACKGROUND

With the advancement of technology and the increase in the demand for mobile devices, the demand for electrochemical devices (such as a lithium-ion battery) is increasing significantly. In order to provide electrochemical devices of a high energy density, high discharge performance, and high cycle performance, one of the main research directions in the field of electrochemical energy storage is to research and improve an electrode material in the electrochemical devices.

Currently; most of commercial electrochemical devices use graphite as a negative active material of electrodes. However, the gravimetric capacity of graphite is relatively low. Compared with graphite, a silicon-based material as a negative active material possesses a higher theoretical gravimetric capacity, and is a mainstream negative active material to be developed in the future for electrochemical devices of a high volumetric energy density. However, in practical applications, such a negative active material of a high energy density incurs a huge volume change effect in lithiation and delithiation processes, and may reduce the cycle performance of the electrochemical devices and exhibit inferior performance of first-cycle Coulombic efficiency. The technical solution for improvement using a silicon-based material still incur a plurality of different defects.

In view of this, there is a real need for continued research and improvement of negative electrode materials and negative active materials to enhance the battery capacity, cycle performance, and C-rate performance of the electrochemical devices.

### SUMMARY

Some embodiments of this application provide a negative active material and an electrochemical device containing same to solve at least one problem in the related art to at least some extent.

According to an aspect of this application, some embodiments of this application provide a negative active material. The negative active material includes a magnesium-doped carbon-silicon-oxide material. Carbon nanotubes encapsulate particles of the magnesium-doped carbon-silicon-oxide material, so that the magnesium-doped carbon-silicon-oxide material further includes a carbon nanotube cladding layer. The carbon nanotube cladding layer overlays a surface of a crystalline oxide of the magnesium-doped carbon-silicon-oxide material. By employing the magnesium-doped carbon-silicon-oxide material, the negative active material of this application is doped with magnesium and can optimize the first-cycle Coulombic efficiency of the carbon-silicon-oxide material, and enhance the C-rate performance of the carbon-silicon-oxide material. The carbon nanotube cladding layer overlays the surface of the particles of the crystalline oxide of the magnesium-doped carbon-silicon-oxide material, thereby forming a conductive network structure, and enhancing the electrical conductivity of the negative active material.

According to another aspect of this application, some embodiments of this application provide an electrochemical device. The electrochemical device includes a negative electrode. The negative electrode includes a negative active material layer. The negative active material layer includes a negative active material. The negative active material includes a magnesium-doped carbon-silicon-oxide material. The magnesium-doped carbon-silicon-oxide material includes a carbon nanotube cladding layer. The carbon nanotube cladding layer overlays a surface of a crystalline oxide of the magnesium-doped carbon-silicon-oxide material. By employing the magnesium-doped carbon-silicon-oxide material coated with a carbon nanotube capping layer, the electrochemical device of this application can improve the first-cycle Coulombic efficiency of the electrochemical device, optimize structural stability of the electrochemical device during cycling, and in turn, improve a cycle capacity retention rate and cycle performance of the electrochemical device.

According to some embodiments of this application, a general formula of the crystalline oxide of the magnesium-doped carbon-silicon-oxide material is Mg_{z}SiCₓO_{y}, where 0<<<0.3, 0.4<y<1.0, and 0.1<z<0.2.

According to some embodiments of this application, in the magnesium-doped carbon-silicon-oxide material, a molar percent of silicon is 40 mol % to 70 mol %, a molar percent of carbon is 3.5 mol % to 24 mol %, and a molar percent of magnesium is 7.0 mol % to 7.5 mol %.

According to some embodiments of this application, in the magnesium-doped carbon-silicon-oxide material, a molar ratio between magnesium and silicon is 0.1 to 0.2, and a molar ratio between magnesium and carbon is 0.2 to 10.0.

According to some embodiments of this application, in a Raman spectrum of the magnesium-doped carbon-silicon-oxide material, an I_{D}/I_{G} value is 0.023 to 0.32.

According to some embodiments of this application, in a Raman spectrum of the magnesium-doped carbon-silicon-oxide material, a ratio of an I_{D}/I_{G} value to the molar percent of carbon is 0.095 to 6.78.

According to some embodiments of this application, a thickness of the carbon nanotube cladding layer is 0.5 nm to 5.0 μm.

According to some embodiments of this application, the carbon nanotube cladding layer includes a carbon nanotube cluster. The carbon nanotube cluster extends from a surface of the carbon nanotube cladding layer. A length of the carbon nanotube cluster is 0.1 μm to 1.0 μm.

According to some embodiments of this application, the negative active material layer further includes a binder. The binder includes synthetic rubber. The synthetic rubber includes one or more of polyacrylate, polyimide, polyamide, polyamide imide, polyvinylidene difluoride, styrene butadiene rubber, sodium alginate, polyvinyl alcohol, polytetrafluoroethylene, polyacrylonitrile, sodium carboxymethyl cellulose, potassium carboxymethyl cellulose, sodium hydroxypropyl cellulose, or potassium hydroxypropyl cellulose.

In some embodiments of this application, based on a total mass of the negative active material layer, a mass percent of the binder is 2 wt % to 6 wt %.

According to some embodiments of this application, an electrolyte solution of the electrochemical device includes an organic solvent and a lithium salt. The organic solvent includes one or more of ethylene carbonate (EC), propylene carbonate (PC), diethyl carbonate (DEC), ethyl methyl carbonate (EMC), dimethyl carbonate (DMC), propylene carbonate, vinylene carbonate, propyl propionate, or ethyl propionate. The lithium salt includes one or more of lithium hexafluorophosphate LiPF₆, lithium tetrafluoroborate LiBF₄, lithium difluorophosphate LiPO₂F₂, lithium bistrifluoromethanesulfonimide LIN(CF₃SO₂)₂, lithium bis(fluorosulfonyl)imide Li(N(SO₂F)₂), lithium bis(oxalate) borate LiB(C₂O₄)₂, or lithium difluoro(oxalate)borate LiBF₂(C₂O₄).

Additional aspects and advantages of some embodiments of this application will be partly described or illustrated herein later or expounded through implementation of an embodiment of this application.

### BRIEF DESCRIPTION OF DRAWINGS

For ease of describing an embodiment of this application, the following outlines the drawings needed for describing an embodiment of this application or the prior art. Evidently, the drawings outlined below are merely a part of embodiments in this application. Without making any creative efforts, a person skilled in the art can still derive the drawings of other embodiments according to the structures illustrated in the drawings.

FIG. 1 is a schematic structural diagram of a particle of a negative active material according to some embodiments of this application;

FIG. 2 is an X-ray diffraction pattern of a magnesium-doped carbon-silicon-oxide material according to Embodiment 1 of this application:

FIG. 3 is a 5000× SEM image of a negative active material viewed in a scanning electron microscope (SEM) according to Embodiment 1 of this application; and

FIG. 4 shows a cycle capacity curve of an electrochemical device according to Embodiment 1 versus Comparative Embodiment 1 of this application.

### DETAILED DESCRIPTION

Some embodiments of this application will be described in detail below. No embodiment of this application is to be construed as a limitation on this application.

Unless otherwise expressly specified, the following terms used herein have the meanings defined below.

The terms “roughly;” “substantially,” “substantively”, and “approximately” used herein are intended to describe and represent small variations. When used together with an event or situation, the term “approximately” may represent an example in which the event or situation occurs exactly or an example in which the event or situation occurs very approximately. For example, when used together with a numerical value, the term “approximately” may represent a variation range falling within ±10% of the numerical value, such as ±5%, ±4%, ±3%, ±2%, ±1%, ±0.5%, ±0.1%, or ±0.05% of the numerical value. For example, if a difference between two numerical values falls within ±10% of an average of the numerical values (such as ±5%, ±4%, ±3%, ±2%, ±1%, ±0.5%, ±0.1%, or ±0.05% of the average), the two numerical values may be considered “substantially” the same.

In the detailed description of embodiments and claims, a list of items recited by using the terms such as “at least one of”, “at least one thereof”, “one or more of”, “one or more thereof” may mean any combination of the recited items. For example, if items A and B are recited, the phrases “one or more of A and B” and “one or more of A or B” mean: A alone: B alone: or both A and B. In another example, if items A, B, and C are recited, the phrases “one or more of A, B, and C” and “one or more of A, B, or C” mean: A alone: B alone: C alone: A and B (excluding C): A and C (excluding B): B and C (excluding A): or all of A, B, and C. The item A may include a single element or a plurality of elements. The item B may include a single element or a plurality of elements. The item C may include a single element or a plurality of elements.

Further, for ease of description, “first”, “second”, “third”, and the like may be used herein to distinguish between different components in one drawing or a series of drawings. Unless otherwise expressly specified or defined, the terms “first”, “second”, “third”, and the like are not intended to describe the corresponding components.

In the field of electrochemical energy storage, in order to pursue an optimum energy density, attempts have been made to replace graphite in the conventional negative active material with a negative active material of a high energy density. However, in applying such a negative active material of a high energy density, the negative active material needs to be further processed due to different material properties. For example, silicon-based materials are mainstream negative active materials to be developed in the future for electrochemical devices (such as a lithium-ion battery) with a high volumetric energy density by virtue of a theoretical gram capacity as high as 4200 mAh/g. Such a negative active material of a high energy density incurs a huge volume change effect (for example, by more than approximately 300%) in lithiation and delithiation processes. Severe expansion of a negative electrode may cause deformation of an interface between the negative electrode and the separator or even cause detachment of the separator, thereby deteriorating cycle performance of the lithium-ion battery. At the same time, due to the unstable lithium ion path during lithiation and delithiation of the silicon-based material, the deposition of lithium metal is prone to be non-uniform, or even a phenomenon of dead lithium may occur, thereby deteriorating the first-cycle Coulombic efficiency of an electrochemical device that employs a negative active material containing a silicon-based material. The first-cycle Coulombic efficiency directly reflects the electrochemical performance of the electrochemical device.

The Chinese patent CN108767241A discloses a negative electrode material that employs a magnesium-doped silicon oxide formed by doping a silicon oxide material with magnesium, so as to enhance the C-rate performance and the first-cycle Coulombic efficiency of a lithium-ion battery. However, during charge-discharge cycles, due to insufficient electrical conductivity of the magnesium-doped silicon oxide and a high volume expansion rate during lithiation and delithiation, the magnesium-doped silicon oxide as a negative active material is still unable to effectively form uniform lithium metal deposition, thereby resulting in a low cycling efficiency of the magnesium-doped silicon oxide and a low service life.

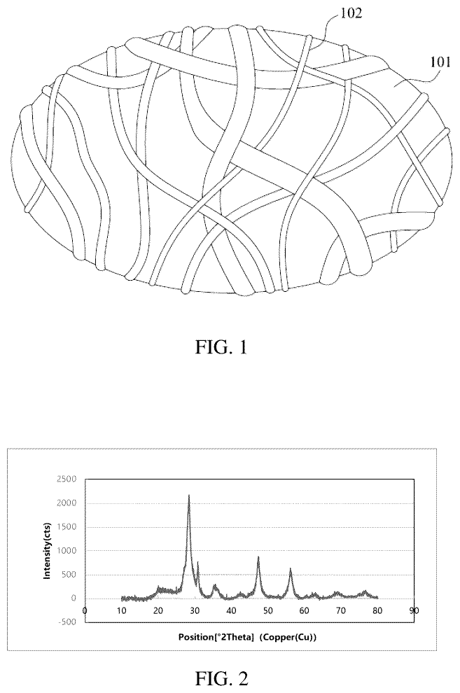

In view of the above problems, according to an aspect of this application, as shown in FIG. 1, some embodiments of this application provide a negative active material. The negative active material includes a composite material formed in a high-temperature manufacturing process by doping a silicon oxide with carbon and magnesium, that is, a magnesium-doped carbon-silicon-oxide material. Further, the surface of a crystalline oxide 101 of the magnesium-doped carbon-silicon-oxide material further includes a carbon nanotube cladding layer 102. The carbon nanotube cladding layer 102 overlays the surface of particles of the crystalline oxide 101 of the magnesium-doped carbon-silicon-oxide material by a carbon nanotube cladding process.

In this application, by doping the silicon-oxygen material with magnesium, a magnesium-silicon oxide is formed to improve the first-cycle Coulombic efficiency of the electrochemical device. In addition, by carbon doping, a carbon-containing magnesium-silicon oxide can be further formed in the composite magnesium-doped carbon-silicon-oxide material. The carbon-containing magnesium-silicon oxide exhibits a relatively low volume expansion rate and a relatively high cycling structural stability during lithiation and delithiation. The magnesium-doped carbon-silicon-oxide material can effectively form uniform lithium metal deposition during cycling, so as to improve the cycle performance and increase the service life of the electrochemical device. In addition, in this application, the carbon nanotubes overlay the surface of the particles of the magnesium-doped carbon-silicon-oxide material, thereby further improving the electrical conductivity of the negative active material.

The magnesium-doped carbon-silicon-oxide material is a composite material that includes a crystalline oxide and carbon nanotubes that overlay the surface of the crystalline oxide, and the crystalline oxide includes magnesium, carbon, silicon, and oxygen. In some embodiments, the crystalline oxide of the magnesium-doped carbon-silicon-oxide material is expressed by a general formula Mg_{z}SiCₓO_{y}. In some embodiments, stoichiometry of the general formula Mg_{z}SiCₓO_{y} of the crystalline oxide of the magnesium-doped carbon-silicon-oxide material is: 0<x<0.3, 0.4<y<1.0, and 0.1<z<0.2. In some embodiments. 0.15<<<0.28, 0.6<<0.8, and 0.1<z<0.2. In some embodiments, 0.2<x<0.25, 0.7<y<0.78, and 0.1<z<0.2.

The constituents of the magnesium-doped carbon-silicon-oxide material and the crystal structure composition thereof exert an impact on the cycle performance, gravimetric capacity, and structural stability of the material in the electrochemical device. In some embodiments, the molar percent of Si in the magnesium-doped carbon-silicon-oxide material is 40 mol % to 70 mol %. An unduly low content of Si may result in a decrease in the gravimetric capacity of the negative active material, and an unduly high content of Si may result in an increase in the volume expansion rate of the negative active material. In some embodiments, the molar percent of Si in the magnesium-doped carbon-silicon-oxide material is 60 mol %.

In some embodiments, the molar percent of Mg in the magnesium-doped carbon-silicon-oxide material is 7.00 mol % to 7.5 mol %. The magnesium content falling within the specified range enables effective formation of a carbon-containing magnesium-silicon oxide, and prevents magnesium and oxygen from forming a highly active magnesium oxide or magnesium metal, thereby increasing the first-cycle Coulombic efficiency of the magnesium-doped carbon-silicon-oxide material used as a negative active material, and decreasing the safety risk of the magnesium-doped carbon-silicon-oxide material in the electrochemical cycling reaction.

In some embodiments, the molar percent of carbon C in the magnesium-doped carbon-silicon-oxide material is 3.5 mol % to 24 mol %. The source of carbon in the magnesium-doped carbon-silicon-oxide material includes the carbon added in the crystalline oxide and the carbon nanotubes that encapsulate the crystalline oxide. An unduly low doping amount of carbon may reduce the structural stability of the negative active material and increase the volume expansion rate. An unduly high doping amount of carbon may decrease the gravimetric capacity of the negative active material. In some embodiments, the molar percent of carbon C in the magnesium-doped carbon-silicon-oxide material is 4.5 mol % to 10 mol %. In some embodiments, the molar percent of carbon C in the magnesium-doped carbon-silicon-oxide material is approximately 6 mol %.

Understandably, the content of constituent elements in the magnesium-doped carbon-silicon-oxide material in this application may be assayed by using any appropriate assay method in the art. The assay method is not limited herein. In some embodiments, the magnesium content and silicon content in the magnesium-doped carbon-silicon-oxide material can be determined by X-ray diffractometry. In some embodiments, the carbon content in the magnesium-doped carbon-silicon-oxide material can be determined by the following carbon content test (insert the reference standard number here if any): Heating a specimen of the negative electrode material in a high-frequency furnace under an oxygen-rich condition to combust the specimen at a high temperature so that carbon and sulfur are oxidized into a gas of carbon dioxide and sulfur dioxide respectively: treating the gas, and passing the gas into a corresponding absorption pool to absorb corresponding infrared radiation, and then converting the absorbed infrared beam into corresponding signals by using a detector. Converting the signals, which are sampled and linearly corrected by a computer, into a value proportional to the concentration of the carbon dioxide or sulfur dioxide. Summing all such values obtained in the entire analysis process. Upon completion of the analysis, dividing the sum by the weight value through the computer, and then multiplying by a correction coefficient, and deducting blank values to obtain the mass percent of carbon or sulfur in the specimen. Testing the specimen by using a high-frequency infrared carbon-sulfur analyzer (HCS-140, manufactured by Shanghai Dekai Instrument Co., Ltd.).

FIG. 2 is an X-ray diffraction pattern of a magnesium-doped carbon-silicon-oxide material according to Embodiment 1 of this application: As shown in FIG. 2, in an embodiment, the magnesium-doped carbon-silicon-oxide material is analyzed by X-ray diffraction. The XRD diffraction pattern exhibits characteristic peaks of one or more of Si, SiO₂, MgSiO₃, or Mg₂SiO₄ contained in the magnesium-doped carbon-silicon-oxide material. In some embodiments, in the magnesium-doped carbon-silicon-oxide material, the molar ratio between magnesium and silicon is 0.1 to 0.2, and the molar ratio between magnesium and carbon is 0.2 to 10.0, thereby optimizing the cycle performance and first-cycle Coulombic efficiency of the magnesium-doped carbon-silicon-oxide material in the electrochemical device. In some embodiments, in the magnesium-doped carbon-silicon-oxide material, the molar ratio between magnesium and silicon is approximately 0.12.

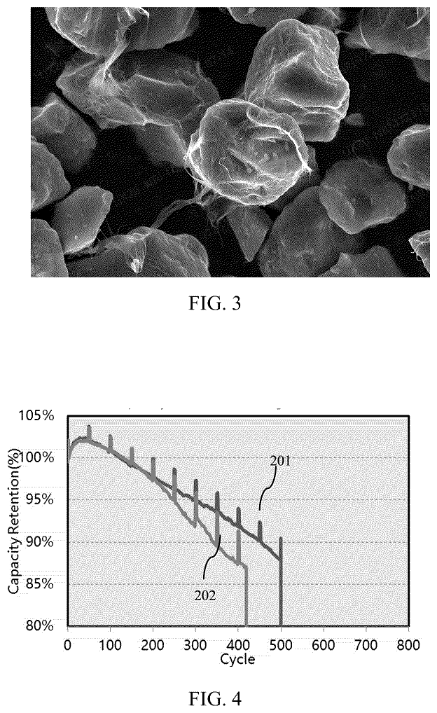

FIG. 3 is a 5000× SEM image of the magnesium-doped carbon-silicon-oxide material viewed in a scanning electron microscope (SEM) according to Embodiment 1 of this application. As can be seen from FIG. 3, the carbon nanotube cladding layer provided on the surface of the particles of the crystalline oxide of the magnesium-doped carbon-silicon-oxide material can form a conductive network structure, thereby further improving the distribution of lithium metal deposition during cycling, optimizing the distribution of the volume expansion of the magnesium-doped carbon-silicon-oxide material, and enabling the negative active material to exhibit excellent structural stability during cycling.

In some embodiments, the thickness of the carbon nanotube cladding layer can affect the electrical conductivity and energy density of the magnesium-doped carbon-silicon-oxide material in the electrochemical device. An unduly large thickness of the carbon nanotube cladding layer may reduce the gravimetric capacity of the magnesium-doped carbon-silicon-oxide material. An unduly small thickness of the carbon nanotube cladding layer may reduce the electrical conductivity and fail to improve the structural stability of the magnesium-doped carbon-silicon-oxide material. In some embodiments, the thickness of the carbon nanotube cladding layer is approximately 0.5 nm, 1.0 nm, 5 nm, 10 nm, 50 nm, 100 nm, 250 nm, 500 nm, 1.0 μm, 5.0 μm, or a value falling within a range formed by any two thereof. In some embodiments, the thickness of the carbon nanotube cladding layer is 0.5 nm to 5.0 μm. In some embodiments, the thickness of the carbon nanotube cladding layer is 2.0 nm to 150 nm.

In some embodiments, the carbon nanotube cladding layer includes a carbon nanotube cluster. The carbon nanotube cluster can extend outward from the surface of the particles of the magnesium-doped carbon-silicon-oxide material, and contact the carbon nanotube cladding layer on the surfaces of other particles, so as to further form an effective conductive network and optimize the electrical conductivity of the magnesium-doped carbon-silicon-oxide material. In some embodiments, the extension length of the carbon nanotube cluster is 0.1 μm to 1.0 μm. In some embodiments, the extension length of the carbon nanotube cluster is approximately 0.5 μm.

In this application, the thickness of the carbon nanotube cladding layer and the extension length of the carbon nanotube cluster may be measured by using any appropriate measurement method in the art. The measurement method is not limited herein. In some embodiments, the thickness of the carbon nanotube cladding layer and the extension length of the carbon nanotube cluster are characterized by a scanning electron microscope (SEM) or transmission electron microscope (TEM). In some embodiments, the characterization parameters of a scanning electron microscope are recorded by using a Philips XL-30 field emission scanning electron microscope, and the measurement is performed in an SEM test under conditions of 10 kV and 10 mA.

In some embodiments, the particle diameter (Dv₅₀) of the magnesium-doped carbon-silicon-oxide material is 2.5 μm to 10.0 μm. In some embodiments, the particle diameter (Dv₅₀) of the magnesium-doped carbon-silicon-oxide material is 2.7 μm to 5.3 μm, thereby optimizing the coating distribution of the magnesium-doped carbon-silicon-oxide material in the negative active material layer. In some embodiments, the particle size distribution of particles of the magnesium-doped carbon-silicon-oxide material satisfies the following condition:

$$0.3 \leq D {n}_{10} / {Dv}_{50} \leq 0.6 .$$

Unless otherwise expressly defined, the term “particle size” or “particle diameter” herein means particle characteristics, such as Dn₁₀ or Dv₅₀, of a specimen measured by a particle size test. Dn₁₀ is a particle diameter of the sample material corresponding to a cumulative number percentage 10% of the total number of the sample particles in a number-based particle size distribution curve as viewed from a small-diameter side. Dv₅₀ is a particle diameter of the sample material corresponding to a cumulative volume percentage 50% of the total volume of the sample particles in a volume-based particle size distribution curve as viewed from a small-diameter side. In some embodiments, the particle diameter is measured with a Mastersizer 2000 laser particle size distribution analyzer by analyzing the particle diameter of the samples. The measurement steps include: dispersing the samples in 100 mL of dispersant (deionized water), and making the shading degree reach 8% to 12%; ultrasonicating the samples at an ultrasonic intensity of 40 KHz and 180 W for 5 minutes; and analyzing the laser particle size distribution of the samples after the ultrasonication, so as to obtain particle size distribution data.

In some embodiments, a specific surface area of particles of the magnesium-doped carbon-silicon-oxide material is 1 m²/g to 50 m²/g. In some embodiments, the specific surface area of particles of the magnesium-doped carbon-silicon-oxide material is 5 m²/g to 20 m²/g, thereby maintaining an appropriate reaction rate between the magnesium-doped carbon-silicon-oxide material and the electrolyte solution.

In some embodiments, the degree of cladding and the structural stability of the carbon nanotube cladding layer in the magnesium-doped carbon-silicon-oxide material can be characterized by Raman spectroscopy: In a Raman spectrum, the D peak and the G peak near approximately 1350 cm⁻¹ and 1580 cm⁻¹ are characteristic peaks of the Raman spectrum of the carbon atom crystals. In some embodiments, the ratio of the peak intensity between the characteristic peaks D and G of the magnesium-doped carbon-silicon-oxide material in the Raman spectrum, denoted as I_{D}/I_{G}, can characterize the soundness of the conductive network structure formed by the carbon nanotube cladding layer on the surface of the particles of the magnesium-doped carbon-silicon-oxide material. When the I_{D}/I_{G} value of the magnesium-doped carbon-silicon-oxide material in the Raman spectrum is relatively low, the conductive network structure of the carbon nanotube cladding layer is relatively complete. In some embodiments, the I_{D}/I_{G} value of the magnesium-doped carbon-silicon-oxide material in the Raman spectrum is less than or equal to 0.32. In some embodiments, the I_{D}/I_{G} value of the magnesium-doped carbon-silicon-oxide material in the Raman spectrum is 0.023 to 0.32, thereby optimizing the conductive network structure of the carbon nanotube cladding layer.

In some embodiments, the ratio of the I_{D}/I_{G} value of the magnesium-doped carbon-silicon-oxide material in the Raman spectrum to the molar percent of carbon can more specifically characterize the degree of cladding of the carbon nanotube cladding layer for the magnesium-doped carbon-silicon-oxide material. When the ratio of the I_{D}/I_{G} value of the magnesium-doped carbon-silicon-oxide material in the Raman spectrum to the molar percent of carbon is unduly low, the gravimetric capacity of the magnesium-doped carbon-silicon-oxide material will be reduced. When the ratio of the I_{D}/I_{G} value of the magnesium-doped carbon-silicon-oxide material in the Raman spectrum to the molar percent of carbon is unduly high, the degree of cladding of the carbon nanotube cladding layer for the magnesium-doped carbon-silicon-oxide material will be low. In some embodiments, in the Raman spectrum of the magnesium-doped carbon-silicon-oxide material, the ratio of the I_{D}/I_{G} value to the molar percent of carbon is 0.095 to 6.78.

According to another aspect of this application, some embodiments of this application provide a method for preparing the magnesium-doped carbon-silicon-oxide material, including the following steps:

(1) Mixing a carbon nanotube feedstock with ethanol to formulate an ethanol dispersion solution in which the carbon nanotubes are of a specified concentration. In some embodiments, the mass percent of the carbon nanotubes in the ethanol dispersion solution is 1.5 wt % to 10.0 wt %. In some embodiments, the mass percent of the carbon nanotubes in the ethanol dispersion solution is 1.6 wt % to 6.6 wt %.

(2) Mixing a precursor of the magnesium-doped carbon-silicon-oxide material with the ethanol dispersion solution, and stirring well. Evaporating the mixture of the precursor of the carbon-silicon-oxide material and the ethanol dispersion solution until dryness, and collecting the dry powder.

(3) Performing high-temperature treatment on the collected dry powder in an argon atmosphere to obtain a magnesium-doped carbon-silicon-oxide material. In some embodiments, the high-temperature treatment is performed at a temperature of 400° C. to 800° C. In some embodiments, the high-temperature treatment is performed at a temperature of approximately 600° C. In some embodiments, the high-temperature treatment is performed for 1 hour to 5 hours. In some embodiments, the high-temperature treatment is performed for approximately 3 hours.

In this application, the ethanol dispersion solution enables the carbon nanotubes to overlay the precursor of the magnesium-doped carbon-silicon-oxide material to form a magnesium-doped carbon-silicon-oxide material overlaid with a carbon nanotube cladding layer. Compared with the negative active material treated by carbon coating alone or carbon doping alone, the magnesium-doped carbon-silicon-oxide material overlaid with a carbon nanotube cladding layer in this application not only improves the electrical conductivity, but also reduces the adverse effect caused by the carbon material on the electrical performance and gravimetric capacity of the magnesium-doped carbon-silicon-oxide material, and optimizes the electrical performance and the cycle performance of the magnesium-doped carbon-silicon-oxide material in the electrochemical device. In some embodiments, by adjusting the temperature and reaction time of the high-temperature treatment, the conductivity and the cladding structure of the carbon nanotube cladding layer in the magnesium-doped carbon-silicon-oxide material can be further optimized, so that the material used as a negative active material can exhibit excellent cycle performance and first-cycle Coulombic efficiency:

According to another aspect of this application, some embodiments of this application provide an electrochemical device. The electrochemical device includes a negative electrode. The negative electrode includes a negative active material layer. The negative active material layer includes a negative active material. The negative active material includes a magnesium-doped carbon-silicon-oxide material disclosed in the preceding embodiment. By employing the magnesium-doped carbon-silicon-oxide material coated with a carbon nanotube capping layer, the electrochemical device can improve the first-cycle Coulombic efficiency of the electrochemical device, optimize structural stability of the electrochemical device during cycling, and in turn, improve a cycle capacity retention rate and cycle performance of the electrochemical device. In some embodiments, based on the total mass of the negative active material, the mass percent of the magnesium-doped carbon-silicon-oxide material is greater than or equal to 20 wt %. In some embodiments, the mass percent of the magnesium-doped carbon-silicon-oxide material is greater than or equal to 60 wt %. In some embodiments, the negative active material includes the magnesium-doped carbon-silicon-oxide material disclosed in the preceding embodiment.

In some embodiments, the negative active material further includes graphite. The graphite includes one or more of natural graphite, artificial graphite, or mesocarbon microbeads (MCMB), thereby improving the electrical conductivity and cycle performance of the negative active material. Without departing from the essence of this application, the negative active material may further include other common negative active materials in the art that are capable of absorbing and releasing lithium (Li), including but not limited to, one or more of carbon material, metal compound, oxide, sulfide, lithium nitride such as LiN₃, lithium metal, metallic and semi-metallic elements that combine with lithium to form alloys, polymer material, or any combination thereof.

In some embodiments, the negative active material can control the powder conductivity of the negative active material by adjusting the content of magnesium-doped carbon-silicon-oxide material, so as to optimize the cycle performance of the negative active material layer. In some embodiments, the powder conductivity of the negative active material is 2.0 S/cm to 30 S/cm. In some embodiments, the powder conductivity of the negative active material is 5.0 S/cm to 10 S/cm. In this application, the powder conductivity of the negative active material may be measured by using any appropriate measurement method in the art. The measurement method is not limited herein. In some embodiments, the powder conductivity of the negative active material is measured in the following process: using a resistivity meter (ST-2255A, by Suzhou Jingge Electronic Co., Ltd.), taking 5 grams of powder specimen, applying an electronic press to set a constant pressure of 5000 kg±2 kg, keeping the constant pressure for 15 to 25 seconds, placing the specimen between the electrodes of the resistivity meter, and calculating the powder conductivity as: 8=h/(S*R)/1000, where h is the height of the specimen (cm), R is the resistance (KΩ), and S is the area (3.14 cm²) of the powder specimen pressed into a sheet.

In some embodiments, the resistance of the negative active material layer ranges from 0.2 (2Ω to 1Ω.

In some embodiments, the negative active material layer further includes a binder, so as to improve structural stability of the negative active material layer. In some embodiments, the binder includes synthetic rubber. The synthetic rubber includes one or more of polyacrylate, polyimide, polyamide, polyamide imide, polyvinylidene difluoride, styrene butadiene rubber, sodium alginate, polyvinyl alcohol, polytetrafluoroethylene, polyacrylonitrile, sodium carboxymethyl cellulose, potassium carboxymethyl cellulose, sodium hydroxypropyl cellulose, or potassium hydroxypropyl cellulose. In some embodiments, based on a total mass of the negative active material layer, a mass percent of the binder is 2 wt % to 6 wt %. In some other embodiments, based on the total mass of the negative active material, roughly the mass percent of the binder is, for example, approximately 2 wt %, approximately 3 wt %, approximately 4 wt %, approximately 5 wt %, approximately 6 wt %, or a value falling within a range formed by any two thereof.

In some embodiments, the negative active material layer further includes a conductive agent, so as to improve the electrical conductivity of the negative active material layer. The conductive agent includes one or more of carbon nanotubes, conductive carbon black, acetylene black, graphene, or Ketjen black. Understandably, a person skilled in the art may select a conventional conductive agent according actual requirements without limitation. In some embodiments, based on the total mass of the negative active material layer, a mass percent of the conductive agent is 1 wt % to 10 wt %. In some other embodiments, based on the total mass of the negative active material, roughly the mass percent of the conductive agent is, for example, approximately 1 wt %, approximately 2 wt %, approximately 3 wt %, approximately 5 wt %, approximately 10 wt %, or a value falling within a range formed by any two thereof.

In some embodiments, the negative electrode further includes a negative current collector. The negative current collector may be copper foil or nickel foil. However, other negative current collectors commonly used in the art may be used without limitation.

In some embodiments, the electrochemical device further includes a positive electrode and a separator. The positive electrode, the separator, and the negative electrode disclosed in the preceding embodiment can be wound or stacked to form an electrode assembly. Without departing from the essence of this application, the electrode assembly in this application may be any appropriate electrode assembly in the art, and constitutes no limitation. In some embodiments, the electrode assembly assumes a jelly-roll structure. In some embodiments, the electrode assembly may assume a stacked structure or a multi-tab structure. In some embodiments, the electrochemical device is a lithium-ion battery.

In some embodiments, the positive electrode includes a positive current collector and a positive active material layer. The positive current collector may be aluminum foil or nickel foil. However, other positive current collectors commonly used in the art may be used without limitation. In some embodiments, the positive active material layer includes a positive active material capable of absorbing and releasing lithium (Li) (hereinafter sometimes referred to as “positive active material capable of absorbing/releasing lithium Li”). Examples of the positive active material capable of absorbing/releasing lithium (Li) may include one or more of lithium cobalt oxide, lithium nickel cobalt manganese oxide, lithium nickel cobalt aluminum oxide, lithium manganese oxide, lithium iron manganese phosphate, lithium vanadium phosphate, lithium vanadyl phosphate, lithium iron phosphate, lithium titanium oxide, and a lithium-rich manganese-based materials.

In some embodiments, the positive active material layer may further include at least one of a binder or a conductive agent. The binder includes one or more of polyvinylidene fluoride, vinylidene fluoride-hexafluoropropylene copolymer, polyamide, polyacrylonitrile, polyacrylate, polyacrylic acid, polyacrylate, sodium carboxymethyl cellulose, polyvinylpyrrolidone, polyvinyl ether, poly methyl methacrylate, polytetrafluoroethylene, or polyhexafluoropropylene. The conductive agent includes one or more of carbon nanotubes, conductive carbon black, acetylene black, graphene, or Ketjen black. Understandably, a person skilled in the art may select a conventional binder and a conventional conductive agent according actual requirements without limitation.

In some embodiments, the separator includes, but is not limited to, at least one of polyethylene, polypropylene, polyethylene terephthalate, polyimide, and aramid. For example, the polyethylene includes a component selected from at least one of high-density polyethylene, low-density polyethylene, and ultra-high-molecular-weight polyethylene. Especially, the polyethylene and the polypropylene are highly effective in preventing short circuits, and can improve stability of the battery through a turn-off effect. Understandably, a person skilled in the art may select a conventional separator in the art according to actual requirements without limitation.

In some embodiments, the electrochemical device of this application further includes an electrolyte solution. The electrolyte solution includes a lithium salt and an organic solvent.

In some embodiments, the lithium salt includes one or more of lithium hexafluorophosphate (LiPF₆), lithium tetrafluoroborate (LiBF₄), lithium difluorophosphate (LiPO₂F₂), lithium bistrifluoromethanesulfonimide LiN(CF₃SO₂)₂, lithium bis(fluorosulfonyl)imide Li(N(SO₂F)₂), lithium bis(oxalato)borate LiB(C₂O₄)₂, or lithium difluoro(oxalato)borate LiBF₂(C₂O₄). For example, the lithium salt is lithium hexafluorophosphate (LiPF₆) because it provides a high ionic conductivity and improves cycle characteristics.

According to some embodiments, the organic solvent includes one or more of ethylene carbonate (EC), propylene carbonate (PC), diethyl carbonate (DEC), ethyl methyl carbonate (EMC), dimethyl carbonate (DMC), propylene carbonate, vinylene carbonate, propyl propionate, or ethyl propionate. The lithium salt includes one or more of lithium hexafluorophosphate LiPF₆, lithium tetrafluoroborate LiBF₄, lithium difluorophosphate LiPO₂F₂, lithium bistrifluoromethanesulfonimide LiN(CF₃SO₂)₂, lithium bis(fluorosulfonyl)imide Li(N(SO₂F)₂), lithium bis(oxalate) borate LiB(C₂O₄)₂, or lithium difluoro(oxalate)borate LiBF₂(C₂O₄).

In some embodiments, the electrolyte solution further includes an additive. Without departing from the essence of this application, the additive may be any appropriate additive in the art, and constitutes no limitation.

Understandably, without departing from the essence of this application, the methods for preparing the positive electrode, the separator, the negative electrode, and the electrolyte solution in embodiments of this application may be any appropriate conventional method in the art selected as specifically required, and constitute no limitation. In an implementation of the method for manufacturing an electrochemical device, the method for preparing a lithium-ion battery includes: winding, folding, or stacking the negative electrode, the separator, the positive electrode in the preceding embodiments sequentially to form an electrode assembly: putting the electrode assembly into a shell such as an aluminum laminated film, and injecting an electrolyte solution; and then performing steps such as vacuum sealing, static standing, chemical formation, and shaping for the packaged electrode assembly to obtain a lithium-ion battery:

Although the lithium-ion battery is used as an example for description above, a person skilled in the art after reading this application can learn that the film of the negative active material in this application is applicable to other suitable electrochemical devices. Such electrochemical devices include any device in which an electrochemical reaction occurs. Specific examples of the devices include all kinds of primary batteries, secondary batteries, fuel batteries, solar batteries, or capacitors. In particular, the electrochemical device is a lithium secondary battery, including a lithium metal secondary battery, a lithium-ion secondary battery, a lithium polymer secondary battery, or a lithium-ion polymer secondary battery.

Some embodiments of this application further provide an electronic device. The electronic device includes the electrochemical device according to an embodiment of this application.

The electronic device according to this embodiment of this application is not particularly limited, and may be any electronic device known in the prior art. In some embodiments, the electronic device may include, but not limited to, a notebook computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy; game console, watch, electric tool, flashlight, camera, large household battery; lithium-ion capacitor, and the like.

### Embodiments

To illustrate the technical solutions of this application more clearly; the following sets out some specific embodiments and comparative embodiments, performs a Raman test, a cycle performance test, a C-rate performance test, and an expansion rate test on the electrochemical devices (lithium-ion batteries) prepared in the embodiments and comparative embodiments, and records the test methods and test results.

### I. Test Methods

### 1.1 Raman Test

Applying a Raman spectrometer (Jobin Yvon LabRAM HR), where the light source wavelength is 532 nm and the test range is 0 cm⁻¹ to 4000 cm⁻¹: testing the negative active material of 100 μm×100 μm in size, and recording the peak intensities near 1350 cm⁻¹ and 1580 cm⁻¹. Collecting 100 measurement values for each parameter, and calculating the average value to obtain the ratio of peak intensity between the characteristic peak D and the characteristic peak G, denoted as I_{D}/I_{G} value.

### 1.2 Testing the C-Rate Performance

Putting the lithium-ion batteries chemically formed in the following embodiments and comparative embodiments into a 45° C.±2° C. thermostat, leaving the batteries to stand for 2 hours, charging the batteries at a constant current of 0.5 C until the voltage reaches 4.45 V, and then charging the batteries at a constant voltage of 4.45 V until the current reaches 0.025 C, leaving the batteries to stand for 5 minutes, discharging the batteries at a constant current of 0.2 C until the voltage reaches 3.0 V, and recording the discharge capacity at this time as a first-cycle discharge capacity of the lithium-ion battery: Subsequently; charging the batteries at a constant current of 0.5 C until the voltage reaches 4.45 V, and then discharging the batteries at a constant current of 2 C until the voltage reaches 3.0 V, and recording the discharge capacity at this time. Calculating the gravimetric capacity of the negative active material by using the first-cycle discharge capacity; and calculating the first-cycle Coulombic efficiency of the negative active material by using the ratio of the 2 C discharge capacity to the first-cycle discharge capacity.

### 1.3 Testing the Cycle Performance:

Putting a chemically formed lithium-ion battery in each of the following embodiments and comparative embodiments into a 25° C.±2° C. thermostat, leaving the battery to stand for 2 hours, charging the battery at a constant current of 0.5 C until the voltage reaches 4.45 V, charging the battery at a constant voltage of 4.45 V until the current reaches 0.025 C, and leaving the battery to stand for 5 minutes; and discharging the battery at a constant current of 0.3 C until the voltage reaches 3.0 V, thereby completing one charge-discharge cycle. Recording the discharge capacity at this time as a first-cycle discharge capacity of the lithium-ion battery: Repeating the foregoing operations to complete a number (n) of charge-discharge cycles, and recording the discharge capacity at the end of each cycle as an n-cycle discharge capacity. Calculating the ratio of the n-cycle discharge capacity to the first-cycle discharge capacity to obtain a number of ratio values. Plotting a cycle capacity curve based on the ratio values.

Taking 4 lithium-ion batteries for each group, and calculating an average value of a capacity retention rate of the lithium-ion batteries. Cycle capacity retention rate of a lithium-ion battery=(400^{th}-cycle discharge capacity (mAh)/first-cycle discharge capacity (mAh)×100%.

### 1.4 Testing the Cycle Thickness Expansion Rate

Measuring the thickness of a lithium-ion battery by using a 600 g parallel plate gauge (ELASTOCON, EV 01).

Putting the chemically formed lithium-ion batteries in the following embodiments and comparative embodiments into a 25° C.±2° C. thermostat, leaving the batteries to stand statically for 2 hours, charging the batteries at a constant current of 0.7 C until the voltage reaches 4.45 V, and then charging the batteries at a constant voltage of 4.45 V until the current reaches 0.05 C, and leaving the batteries to statically stand for 15 minutes; recording the thickness of the lithium-ion battery in a fully-charged state: discharging the batteries at a constant current of 0.5 C until the voltage reaches 3.0 V, thereby completing one charge-discharge cycle: recording the thickness of the lithium-ion batteries at the end of the first cycle; and performing 400 charge-discharge cycles according to the foregoing method, and recording the thickness of the lithium-ion battery at the end of the 400th cycle.

Testing the lithium-ion batteries in groups, with each group containing 4 batteries. Calculating an average of the cycle thickness expansion rates of the lithium-ion batteries. Cycle thickness expansion rate of a lithium-ion battery=(thickness of the lithium-ion battery at the end of 400 cycles/thickness of the lithium-ion battery at the end of a first cycle−1)×100%.

### II. Preparation Methods

### 2.1 Preparing a Positive Electrode

Mixing lithium cobalt oxide (LiCoO₂) as a positive active material, conductive carbon black (super P), and polyvinylidene difluoride (PVDF) at a weight ratio of 97.5:1.0:1.5, adding N-methylpyrrolidone (NMP) as a solvent, blending the mixture to form a slurry with a solid content of 0.75, and stirring well. Coating a positive current collector aluminum foil with the slurry evenly, and drying the foil at 90° C. Subsequently, performing steps of cold pressing, cutting, and slitting to obtain a positive electrode.

### 2.2 Preparing an Electrolyte Solution

Mixing a lithium salt LiPF₆ and an organic solvent at a mass ratio of 8:92 in an environment (dry argon atmosphere) in which the moisture content is less than 150 ppm, where the organic solvent is ethylene carbonate (EC), diethyl carbonate (DEC), propylene carbonate (PC), propyl propionate (PP), and vinylene carbonate (VC) mixed at a mass ratio of 20:30:20:28:2, so as to produce a solution serving as an electrolyte solution of the lithium-ion battery.

### 2.3 Preparing a Negative Electrode

Using copper foil as a negative current collector. Mixing the negative active material prepared in each of the embodiments or comparative embodiments with graphite at a mass ratio of 1:1 to obtain a mixed powder in which the designed mixed gravimetric capacity is 850 mAh/g. Stirring the mixed powder, acetylene black, and polyacrylic acid (PAA) at a mass ratio of 95:1.2:3.8 in a deionized water solvent system thoroughly to form a uniform negative active material slurry. Coating the surface of copper foil with the negative active material slurry uniformly, and drying the foil at 90° C. Subsequently, performing cold pressing, cutting, and slitting, and performing drying in an 85° C. vacuum environment for 4 hours to obtain a negative electrode.

### 2.4 Preparing a Lithium-Ion Battery

Using a polyethylene film as a separator, where the thickness of the polyethylene film is 15 μm. Stacking the positive electrode, the separator, and the negative electrode sequentially, and placing the separator between the positive electrode and the negative electrode to serve a separation function. Dehydrating the stacked electrode assembly at 80° C. to obtain a dry electrode assembly. Putting the electrode assembly into an outer package, injecting the prepared electrolytic solution, and performing packaging. Performing steps such as chemical formation, degassing, and edge trimming to obtain a lithium-ion battery:

### 2.5 Preparing a Negative Active Material

### Embodiment 1

(1) Mixing a carbon nanotube feedstock with ethanol to formulate an ethanol dispersion solution in which the mass percent of the carbon nanotubes is 3.3 wt %, where the average particle diameter of the carbon nanotubes is (insert the value here if available).

(2) Mixing the precursor of the magnesium-doped carbon-silicon-oxide material with an ethanol dispersion solution homogeneously, where the precursor is formed by mixing constituents based on a stoichiometric general formula Mg_{0.14}SiC_{0.25}O_{0.77} of the magnesium-doped carbon-silicon-oxide material, and the constituents are a magnesium material (magnesium powder), a carbon material (acetylene gas), and a silicon-oxygen compound material mixed at a mass ratio of 2:1:10. Evaporating the mixture of the precursor of the carbon-silicon-oxide material and the ethanol dispersion solution at a temperature until dryness, and collecting the dry powder.

(3) Performing high-temperature treatment on the collected dry powder in an argon atmosphere to obtain a magnesium-doped carbon-silicon-oxide material, where the high-temperature treatment is performed at approximately 600° ° C. for 3 hours.

### Embodiments 2 and 3

The preparation method is substantially the same as that in Embodiment 1 except that, in step (1), the concentration of the carbon nanotubes in the ethanol dispersion solution is different, as specifically set out for each embodiment in the following table.

### Embodiments 4 to 7

The preparation method is substantially the same as that in Embodiment 1 except that, in step (3), the temperature of the high-temperature treatment is different, as specifically set out for each embodiment in the following table.

### Embodiments 8 and 9

The preparation method is substantially the same as that in Embodiment 3 except that, in step (3), the time of the high-temperature treatment is different, as specifically set out for each embodiment in the following table.

### Comparative Embodiment 1

Performing high-temperature treatment on the precursor of the magnesium-doped carbon-silicon-oxide material in an argon atmosphere, where the precursor is formed by mixing constituents based on a stoichiometric general formula Mg_{0.14}SiC_{0.18}O_{0.8} of the magnesium-doped carbon-silicon-oxide material, and the constituents are a magnesium material (magnesium powder), a carbon material (acetylene gas), and a silicon-oxygen compound material mixed at a mass ratio of 2:1:10, where the high-temperature treatment is performed at approximately 600° C. for 3 hours, so as to obtain a magnesium-doped carbon-silicon-oxide material.

### III. Comparison Results

### 3.1 Comparison of Constituents of Negative Active Material

The lithium-ion batteries in Embodiments 1 to 9 differ from those in Comparative Embodiment 1 in the constituents of the negative active material (after being coated with the carbon nanotube cladding layer) and the precursor (without being coated with the carbon nanotube cladding layer) of the material. The constituents of the precursor of the negative active material and the test results of the magnesium-doped carbon-silicon-oxide material subjected to a constituent test and a Raman test are set out in Table 1.

TABLE 1

| | | | | | | | Thickness | |
|---|---|---|---|---|---|---|---|---|
| | | Negative active material powder | | | | | of carbon | Length |
| | | Silicon | Carbon | Magnesium | | Ratio of | nanotube | of carbon |
| Embodiment/ | | content | content | content | | I_{D}/I_{G} | cladding | nanotube |
| Comparative | Crystalline oxide | test result | test result | test result | I_{D}/I_{G} | value to | layer | cluster |
| Embodiment | stoichiometry | (%) | (%) | (%) | value | carbon | (μm) | (μm) |
| Embodiment 1 | Mg_{0.14}SiC_{0.25}O_{0.77} | 60% | 6.50% | 7.20% | 0.15 | 2.3 | 0.5 | 0.5 |
| Embodiment 2 | Mg_{0.14}SiC_{0.25}O_{0.77} | 60.32% | 4.72% | 7.53% | 0.32 | 6.78 | 0.25 | 0.1 |
| Embodiment 3 | Mg_{0.14}SiC_{0.25}O_{0.77} | 39.80% | 24.30% | 7.11% | 0.02 | 0.10 | 5 | 1 |
| Embodiment 4 | Mg_{0.14}SiC_{0.25}O_{0.77} | 60.05% | 6.43% | 7.13% | 0.16 | 2.46 | 0.45 | 0.48 |
| Embodiment 5 | Mg_{0.14}SiC_{0.25}O_{0.77} | 60.03% | 6.48% | 7.15% | 0.15 | 2.36 | 0.48 | 0.49 |
| Embodiment 6 | Mg_{0.14}SiC_{0.25}O_{0.77} | 59.83% | 6.73% | 7.13% | 0.14 | 2.11 | 0.52 | 0.51 |
| Embodiment 7 | Mg_{0.14}SiC_{0.25}O_{0.77} | 59.69% | 6.86% | 7.08% | 0.14 | 2.03 | 0.55 | 0.49 |
| Embodiment 8 | Mg_{0.14}SiC_{0.25}O_{0.77} | 61.03% | 6.32% | 7.25% | 0.17 | 2.67 | 0.41 | 0.52 |
| Embodiment 9 | Mg_{0.14}SiC_{0.25}O_{0.77} | 58.88% | 6.72% | 7.00% | 0.13 | 1.89 | 0.52 | 0.49 |
| Comparative | Mg_{0.14}SiC_{0.18}O_{0.8} | 61.10% | 3.30% | 7.53% | N/A | N/A | N/A | N/A |
| Embodiment 1 | | | | | | | | |

Note:
“N/A” indicates absence of the corresponding value.

As can be seen from Table 1, by employing a preparation process of the ethanol dispersion solution, this application effectively forms a carbon nanotube cladding layer on the surface of the crystalline oxide of particles of the negative active material. In this way, the carbon content of the negative active material powder after the preparation is higher than that of the negative active material before the preparation. As can be seen from Embodiments 1 to 3, the thickness of the carbon nanotube cladding layer can be controlled by adjusting the concentration of carbon nanotubes in the ethanol dispersion solution. In addition, as can be seen from the results of the Raman test, the thickness of the carbon nanotube cladding layer affects the stability and electrical conductivity of the carbon structure thereof.

As can be seen from Embodiment 1 and Embodiments 4 to 9, the cladding structure of the carbon nanotube cladding layer is affected by the temperature and time of the high-temperature treatment. As can be seen from the results of the Raman test, when the temperature of the high-temperature treatment decreases, the degree of carbonization of the carbon nanotube cladding layer is reduced, and the degree of disorder of the carbon nanotube cladding layer and the defects of the carbon structure are increased. When the temperature of the high-temperature treatment is increased, the degree of carbonization of the carbon nanotube cladding layer is increased, and the degree of disorder of the carbon nanotube cladding layer and the defects of the carbon structure are reduced.

### 3.2 Comparison of Performance of Electrochemical Devices

Table 2 shows the test results of the C-rate test, cycle performance test, and cycle thickness expansion rate test of the lithium-ion batteries in Embodiments 1 to 9 and Comparative Embodiment 1.

TABLE 2

| | First-cycle | Capacity | Thickness |
|---|---|---|---|
| Embodiment/ | Coulombic | retention | expansion |
| Comparative | efficiency | rate after | rate after |
| Embodiment | of material | 400 cycles (%) | 400 cycles |
| Embodiment 1 | 82% | 92.5 | 7.7% |
| Embodiment 2 | 83.40% | 90.1 | 7.6% |
| Embodiment 3 | 81.10% | 91.2 | 7.6% |
| Embodiment 4 | 80.10% | 90.1 | 7.7% |
| Embodiment 5 | 81.30% | 89.1 | 7.7% |
| Embodiment 6 | 75% | 87.9 | 8.2% |
| Embodiment 7 | 72% | 91.6 | 8.6% |
| Embodiment 8 | 81.10% | 87.9 | 7.8% |
| Embodiment 9 | 79.20% | 67.6 | 7.8% |
| Comparative | 82% | 87 | 8.6% |
| Embodiment 1 | | | |

Referring to Table 2, the magnesium-doped carbon-silicon-oxide material according to an embodiment of this application exhibits excellent first-cycle Coulombic efficiency and cycle performance. By further doping the magnesium-doped silicon oxide with carbon, this application enhances the cycle performance of the negative active material, reduces the cycle thickness expansion rate after a large number of cycles, and prolongs the cycle life. Embodiment is further compared with Comparative Embodiment 1. FIG. 4 shows a cycle capacity curve 201 of an electrochemical device in Embodiment 1 versus a cycle capacity curve 202 of an electrochemical device in Comparative Embodiment 1 of this application. As shown in FIG. 4, the electrochemical device in Embodiment 1 of this application includes a magnesium-doped carbon-silicon-oxide material containing a carbon nanotube cladding layer. By disposing a specified carbon nanotube cladding layer, this application can increase the cycle capacity retention rate of the negative active material significantly, and reduce the cycle thickness expansion rate significantly, thereby endowing the electrochemical device with excellent first-cycle Coulombic efficiency and cycle performance.

As can be seen from Embodiments 1 to 3, when the thickness of the carbon nanotube cladding layer is relatively small, the cladding layer is not dense enough to effectively form a continuous and uniform conductive network, thereby reducing the cycle capacity retention rate of the material. When the thickness of the carbon nanotube cladding layer is relatively high, more by-products are accumulated, and a larger amount of electrolyte solution and active lithium is consumed, thereby reducing the cycle capacity retention rate of the material, and reducing the first-cycle Coulombic efficiency of the material.

As can be seen from Embodiments 4 to 9, when the sintering temperature and the degree of carbonization of the magnesium-doped carbon-silicon-oxide material are lowered, the defects of the cladding layer increase, the I_{D}/I_{G} value increases, and the electron conductivity of the conductive network decreases, thereby reducing the cycle capacity retention rate. When the sintering temperature and the degree of carbonization of the magnesium-doped carbon-silicon-oxide material is raised, the defects of the cladding layer decrease, the I_{D}/I_{G} value decreases, and the electron conductivity of the conductive network increases. However, the increase in temperature leads to an increase in the silicate phase in the carbon-doped silicon material, thereby reducing the first-cycle Coulombic efficiency. The increase in the silicate phase also deteriorates the structural stability of the material, thereby reducing the cycle capacity retention rate.

References to “embodiments”, “part of embodiments”, “an embodiment”, “another example”, “example”, “specific example” or “some examples” throughout the specification mean that at least one embodiment or example in this application includes specific features, structures, materials, or characteristics described in the mentioned embodiment(s) or example(s). Therefore, descriptions throughout the specification, which make references by using expressions such as “in some embodiments”, “in an embodiment”, “in one embodiment”, “in another example”, “in an example”, “in a specific example”, or “example”, do not necessarily refer to the same embodiment(s) or example(s) in this application. In addition, specific features, structures, materials, or characteristics herein may be combined in one or more embodiments or examples in any appropriate manner.

Although illustrative embodiments have been demonstrated and described above, a person skilled in the art understands that the foregoing embodiments are never to be construed as a limitation on this application, and changes, replacements, and modifications may be made to the embodiments without departing from the spirit, principles, and scope of this application.

What is claimed is:

1. An electrochemical device, comprising: a negative electrode, wherein the negative electrode comprises a negative active material layer, the negative active material layer comprises a negative active material, the negative active material comprises a magnesium-doped carbon-silicon-oxide material, and a surface of a crystalline oxide of the magnesium-doped carbon-silicon-oxide material is coated with a carbon nanotube cladding layer.

2. The electrochemical device according to claim 1, wherein a general formula of the crystalline oxide of the magnesium-doped carbon-silicon-oxide material is Mg_{z}SiCₓO_{y}, wherein 0<x<0.3, 0.4<y<1.0, and 0.1<z<0.2.

3. The electrochemical device according to claim 1, wherein, in the magnesium-doped carbon-silicon-oxide material, a molar percent of silicon is 40 mol % to 70 mol %, a molar percent of carbon is 3.5 mol % to 24 mol %, and a molar percent of magnesium is 7.0 mol % to 7.5 mol %.

4. The electrochemical device according to claim 1, wherein, in the magnesium-doped carbon-silicon-oxide material, a molar ratio between magnesium and silicon is 0.1 to 0.2, and a molar ratio between magnesium and carbon is 0.2 to 10.0.

5. The electrochemical device according to claim 1, wherein, in a Raman spectrum of the magnesium-doped carbon-silicon-oxide material, an I_{D}/I_{G} value is 0.023 to 0.32.

6. The electrochemical device according to claim 3, wherein, in a Raman spectrum of the magnesium-doped carbon-silicon-oxide material, a ratio of an I_{D}/I_{G} value to the molar percent of carbon is 0.095 to 6.78.

7. The electrochemical device according to claim 1, wherein a thickness of the carbon nanotube cladding layer is 0.5 nm to 5.0 μm.

8. The electrochemical device according to claim 1, wherein the carbon nanotube cladding layer comprises a carbon nanotube cluster, the carbon nanotube cluster extends from a surface of the carbon nanotube cladding layer, and a length of the carbon nanotube cluster is 0.1 μm to 1.0 μm.

9. The electrochemical device according to claim 1, wherein a particle diameter Dv₅₀ of the magnesium-doped carbon-silicon-oxide material is 2.5 μm to 10.0 μm.

10. The electrochemical device according to claim 1, wherein a particle size distribution of the magnesium-doped carbon-silicon-oxide material satisfies 0.3≤Dn₁₀/Dv₅₀≤0.6.

11. The electrochemical device according to claim 1, wherein a specific surface area of the magnesium-doped carbon-silicon-oxide material is 1 m²/g to 50 m²/g.

12. The electrochemical device according to claim 1, wherein the negative active material layer further comprises a binder; the binder comprises synthetic rubber; the synthetic rubber comprises one or more of polyacrylate, polyimide, polyamide, polyamide imide, polyvinylidene difluoride, styrene butadiene rubber, sodium alginate, polyvinyl alcohol, polytetrafluoroethylene, polyacrylonitrile, sodium carboxymethyl cellulose, potassium carboxymethyl cellulose, sodium hydroxypropyl cellulose, or potassium hydroxypropyl cellulose; and, based on a total mass of the negative active material layer, a mass percent of the binder is 2 wt % to 6 wt %.

13. The electrochemical device according to claim 1, further comprising an electrolyte solution, wherein:
the electrolyte solution comprises an organic solvent and a lithium salt;
the organic solvent comprises one or more of ethylene carbonate (EC), propylene carbonate (PC), diethyl carbonate (DEC), ethyl methyl carbonate (EMC), dimethyl carbonate (DMC), propylene carbonate, vinylene carbonate, propyl propionate, or ethyl propionate; and
the lithium salt comprises one or more of lithium hexafluorophosphate LiPF₆, lithium tetrafluoroborate LiBF₄, lithium difluorophosphate LiPO₂F₂, lithium bistrifluoromethanesulfonimide LiN(CF₃SO₂)₂, lithium bis(fluorosulfonyl)imide Li(N(SO₂F)₂), lithium bis(oxalate) borate LiB(C₂O₄)₂, or lithium difluoro(oxalate)borate LiBF₂(C₂O₄).
